(19) United States
(12) Patent Application Publication
(10) Pub. No.: US 2026/0093702 A1
(43) Pub. Date: Apr. 2, 2026

(54) METHOD FOR DATA PROCESSING, APPARATUS, DEVICE, STORAGE MEDIUM AND PROGRAM PRODUCT

(71) Applicant: Beijing Zitiao Network Technology Co., Ltd., Beijing (CN)

(72) Inventors: Wei HUANG, Beijing (CN); Jin MA, Beijing (CN); Shuxuan HUANG, Beijing (CN); Lei WANG, Beijing (CN)

(21) Appl. No.: 19/335,441

(22) Filed: Sep. 22, 2025

(30) Foreign Application Priority Data
Sep. 27, 2024 (CN) 202411365257.7

(51) Int. Cl. G06F 16/2455; G06F 16/248

(52) U.S. Cl. CPC G06F 16/2455; G06F 16/248

(57) ABSTRACT

Provided in the disclosure a method, apparatus, device, storage medium and program product for data processing. A method includes: storing target data into a target area in response to determining the target data, data stored in the target area having a corresponding identification, and the target data determined based on a received user input; performing data analysis on the target data based on a target identification corresponding to the target data; and presenting a reply to the user input based on a result of the data analysis. In this way, after the data is queried, the data is not directly exposed to the subsequent data analysis stage, but instead provided to the subsequent data analysis stage in the form of identification. On one hand, the amount of data communication between different stages can be reduced, on the other hand, the data remains isolated between different stages, enhancing security.

### CROSS-REFERENCE

This application claims the benefit of Chinese Patent Application No. 202411365257.7, filed Sep. 27, 2024, entitled “Method for Data Processing, Apparatus, Device, Storage Medium and Program Product”, the entirety of which are incorporated herein by reference.

### TECHNICAL FIELD

Example embodiments in the disclosure generally relate to the field of computers, and in particular, to a method for data processing, an apparatus, an electronic device, a computer-readable storage medium, and a computer program product.

### BACKGROUND

With the development of information technology, various terminal devices may provide various services for people in aspects such as work and life. Applications that provide services may be deployed on terminal devices. A terminal device may present corresponding content through a user interface of the application and implement interaction with a user, so as to meet various needs of the user. In some cases, in order to meet the needs of the user, various data needs to be processed. Therefore, how to improve the security of data processing is a problem of concern.

### SUMMARY

In a first aspect in the disclosure, a method for data processing is provided. The method includes: storing target data into a target area in response to determining the target data, data stored in the target area having a corresponding identification, and the target data determined based on a received user input; performing data analysis on the target data based on a target identification corresponding to the target data; and presenting a reply to the user input based on a result of the data analysis.

In a second aspect in the disclosure, an apparatus for data processing is provided. The apparatus includes: a data storing module configured to store target data into a target area in response to determining the target data, data stored in the target area having a corresponding identification, and the target data determined based on a received user input; an analysis executing module configured to perform data analysis on the target data based on a target identification corresponding to the target data; and a reply presenting module configured to present a reply to the user input based on a result of the data analysis.

In a third aspect in the disclosure, an electronic device is provided. The electronic device includes at least one processor and at least one memory, the at least one memory is coupled to the at least one processor and stores instructions configured to be executed by the at least one processor, and the instructions, when executed by the at least one processor, cause the electronic device to perform the method according to the first aspect.

In a fourth aspect in the disclosure, a computer-readable storage medium is provided. A computer program is stored in the computer-readable storage medium, and the computer program, when executed by a processor, implements the method according to the first aspect.

In a fifth aspect in the disclosure, a computer program product is provided, including a computer program, where the computer program, when executed by a processor, implements the method according to the first aspect in the disclosure.

It should be understood that the content described in this section is not intended to limit the key features or important features of the embodiments in the disclosure, nor is it intended to limit the scope of the disclosure. Other features in the disclosure will become easily understood through the following description.

### BRIEF DESCRIPTION OF THE DRAWINGS

The above and other features, advantages and aspects of the embodiments in the disclosure will become more apparent when taken in conjunction with the drawings and with reference to the following detailed description. In the drawings, the same or similar reference numerals represent the same or similar elements, where:

FIG. 1 illustrates a schematic diagram of an example environment in which embodiments in the disclosure may be implemented;

FIG. 2 illustrates a flowchart of a process of information processing according to some embodiments in the disclosure;

FIG. 3 illustrates a schematic diagram of an example of information processing according to some embodiments in the disclosure;

FIG. 4 illustrates a schematic structural block diagram of an apparatus for data processing according to some embodiments in the disclosure; and

FIG. 5 illustrates a block diagram of an electronic device that may implement one or more embodiments in the disclosure.

### DETAILED DESCRIPTION OF EMBODIMENTS

The embodiments in the disclosure will be described in more detail below with reference to the drawings. Although some embodiments in the disclosure are shown in the drawings, it should be understood that the disclosure may be implemented in various forms, and should not be interpreted as being limited to the embodiments set forth herein. On the contrary, these embodiments are provided for a more thorough and complete understanding of the disclosure. It should be understood that the drawings and embodiments in the disclosure are only for example purposes, and are not intended to limit the protection scope of the disclosure.

In the description of the embodiments in the disclosure, the term “include/comprise” and similar terms should be understood as open inclusion, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may be included below.

In this document, unless explicitly specified, performing a step “in response to A” does not mean that the step is performed immediately after “A”, but may include one or more intermediate steps.

It should be understood that data involved in the technical solution (including but not limited to the data itself, and the acquisition, use, storage or deletion of the data) should comply with requirements of corresponding laws and regulations and related provisions.

It should be understood that before the technical solutions disclosed in the embodiments in the disclosure are used, the type, use scope, use scene, etc. of information involved in the disclosure should be notified to a related user and authorization of the related user should be obtained according to relevant laws and regulations in an appropriate manner. The related user may include any type of right subject, such as an individual, an enterprise, or a group.

For example, in response to receiving an active request from a user, prompt information is sent to the related user to explicitly prompt the related user that an operation requested to be performed will require the acquisition and use of information of the related user, so that the related user may independently select whether to provide information to software or hardware such as an electronic device, an application, a server, or a storage medium that performs the operation of the technical solution in the disclosure according to the prompt information.

As an optional but non-limiting implementation, in response to receiving an active request from a related user, the prompt information may be sent to the related user in the form of a pop-up window, and the prompt information may be presented in the pop-up window in the form of text. In addition, the pop-up window may further carry a selection control for the user to select “agree” or “disagree” to provide information to the electronic device.

It should be understood that the above process of notifying and obtaining the user's authorization is only schematic, and does not constitute a limitation on implementations in the disclosure. Other manners that satisfy relevant laws and regulations may also be applied to implementations in the disclosure. The enabling of the digital assistant-related functions, the acquired data, the data processing and storage manners, etc. in the embodiments in the disclosure should obtain advance authorization from the user and other right subjects associated with the user, and should comply with agreements on relevant laws and regulations and agreement rules between right subjects.

As used herein, the term “model” can learn an association relationship between a corresponding input and an output from training data, so that a corresponding output may be generated for a given input after the training is completed. The generation of the model may be based on a machine learning technology. Deep learning is a machine learning algorithm that processes an input and provides a corresponding output by using a plurality of processors. A neural network model is an example of a model based on deep learning. In this document, the “model” may also be referred to as a “machine learning model”, a “learning model”, a “machine learning network” or a “learning network”, and these terms are used interchangeably herein.

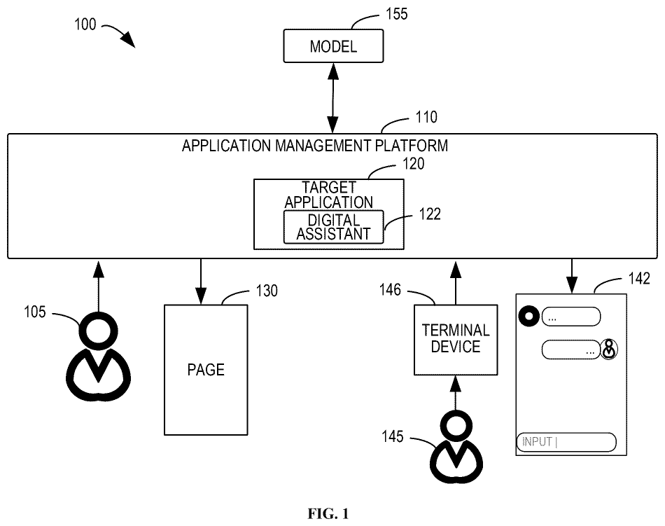

FIG. 1 illustrates a schematic diagram of an example environment 100 in which the embodiments in the disclosure may be implemented. The environment 100 relates to an application management platform 110, which may support the creation and/or execution of applications. In some embodiments, a part of the application management platform 110 that is used to support application creation may also be referred to as an application creation portion. In some embodiments, a part of the application management platform 110 that is used to support application execution may also be referred to as an application execution portion.

As shown in the figure, the application creation portion may provide a user 105 with an application creation and release environment. The user 105 may be referred to as an application creation user or a creator. In some embodiments, the application creation portion may be a low-code platform, which provides a collection of tools for application creation. The application creation portion may support visual development of various applications, so that developers may skip the process of manual coding and speed up the development cycle of applications and reduce the cost. The application creation portion may support any suitable platform for users to develop one or more types of applications, for example, it may include an application platform as a service (aPaaS on) based platform. Such a platform may support users to develop applications efficiently, and implement operations such as application creation and application function adjustment.

The application creation portion may be deployed locally on a terminal device of the user 105, and/or may be supported by a server-side device. For example, the terminal device of the user 105 may run a client of the application creation portion, and the client may support the user to interact with the application creation portion provided by the server-side. In the case where the application creation portion runs locally on the terminal device of the user, the user 105 may directly use the terminal device to interact with the local application creation portion. In the case where the application creation portion runs on the server-side device, the server-side device can realize the service provision to the client running on the terminal device based on a communication connection with the terminal device. The application creation portion may present a corresponding page 130 to the user 105 based on the operation of the user 105, to output to and/or receive from the user 105 information related to application creation.

In some embodiments, the application creation portion may be associated with a corresponding database, which stores data or information required for the application creation process supported by the application creation portion. For example, the database may store codes, description information, and the like corresponding to various functional modules that constitute the application. The application creation portion may further perform operations such as calling, adding, deleting, and updating on the functional modules in the database. The database may also store operations that can be performed on different functional blocks. For example, in a scenario where an application is to be created, the application creation portion may call corresponding functional blocks from the database to build the application.

In the embodiments in the disclosure, the user 105 may create a target application 120 on the application creation portion as needed, and publish the target application 120. The target application 120 may be published to any suitable application execution portion, as long as the application execution portion can support the execution of the target application 120. After being published, the target application 120 may be used for operation by one or more terminal users 145. The terminal users 145 may operate the target application 120 through associated terminal devices 146, and then interact with the application management platform 110. The terminal users 145 may be referred to as terminal users of the target application 120. In some embodiments, the target application 120 may include or be implemented as a digital assistant 122.

The digital assistant 122 may be configured to have an intelligent conversation capability. In the example shown in the figure, the digital assistant 122 may be integrated into the target application 120 and assist in performing task processing in the target application 120 as a part of the target application 120. In other examples, the digital assistant 122 may be configured as an independently running application, such as a web application or other types of applications. In such an example, the digital assistant 122 and the target application 120 may be considered as the same application. The digital assistant 122 is provided to assist the user in various task processing requirements in different applications and scenarios. In the process of interacting with the digital assistant 122, the user inputs an interactive message, and the digital assistant 122 provides a reply message in response to the user input. Generally, the digital assistant 122 can support the user to input a question in a natural language, and perform a task and provide a reply based on an understanding of the natural language input and a logical reasoning ability.

In some embodiments, the digital assistant 122 may interact as a contact of the terminal user 145. For example, the digital assistant 122 may be implemented in an instant messaging (IM) application. The digital assistant 122 may interact with the terminal user 145 in a single chat session with the terminal user 145. In some embodiments, the digital assistant 122 may interact with a plurality of users in a group chat session including a plurality of users.

For each terminal user 145, a client of the application execution portion may present, in a client interface, an interactive window 142 of the target application 120 or the digital assistant 122, such as a chat window with the digital assistant 122. The terminal user 145 may input a chat message in the chat window, and the target application 120 may determine a reply message of the digital assistant 122 based on created configuration information, and present it to the user in the interactive window 142. In some embodiments, depending on the configuration of the target application 120, an interactive message with the target application 120 may include a multi-modal message, such as a text message (for example, a natural language text), a voice message, an image message, a video message, and the like.

Similar to the application creation portion, the application execution portion may be deployed locally on a terminal device of each terminal user 145, and/or may be supported by a server-side device. For example, the terminal device of the terminal user 145 may run a client of the application execution portion, and the client may support the user to interact with the application execution portion provided by the server-side. In the case where the application execution portion runs locally on the terminal device of the user, the terminal user 145 may directly use the terminal device to interact with the local application execution portion. In the case where the application execution portion runs on the server-side device, the server-side device may realize the service provision to the client running on the terminal device based on a communication connection with the terminal device. The application execution portion may present a corresponding application page to the terminal user 145 based on the operation of the terminal user 145, to output to and/or receive from the terminal user 145 information related to application use.

In some embodiments, the implementation of at least some functions of the target application 120, and/or the implementation of at least some functions of the digital assistant 122 in the target application 120 may be implemented based on a model. In the creation or execution process of the target application 120, one or more models 155, for example, capabilities of the models 155, may be invoked. In the target application 120, the digital assistant 122 may use the model 155 to understand the user input, and provide a reply to the user based on an output of the model 155.

In the creation process, the application management platform 110 needs to use the model 155 to determine whether the execution result of the target application 120 meets expectation during the testing of the target application 120. In the execution process, in response to different operation requests from users of the target application 120, the application execution portion may need to use the model 155 to determine the response result to the users.

Although shown as independent of the application management platform 110, the one or more models 155 may run on the application management platform 110 or other remote servers. In some embodiments, the model 155 may be a machine learning model, a deep learning model, a learning model, a neural network, and the like. In some embodiments, the model may be based on a language model (LM). The language model may have a question answering capability by learning from a large amount of corpus. The model 155 may also be based on other suitable models.

The application management platform 110 may run on a suitable electronic device. The electronic device here may be any type of device with computing power, including a terminal device or a server-side device. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a game device, or any combination thereof, including accessories and peripherals of these devices or any combination thereof. The server-side device may include, for example, a computing system/server, such as a mainframe, an edge computing node, a computing device in a cloud environment, and the like. In some embodiments, the management platform 110 may be implemented based on cloud services.

It should be understood that the structure and function of the environment 100 are described only for example purposes, without implying any limitation on the scope of the disclosure. For example, although a single user interacting with the application creation portion and a single user interacting with the application execution portion are illustrated, in fact, a plurality of users may access the application management platform 110 to create digital assistants, and each digital assistant may be used to interact with a plurality of users.

As mentioned above, users may initiate data processing requests in applications to process data in the applications. The processing of the data may involve multiple stages. Conventionally, the application may transfer data to be processed between multiple stages. In this way, on one hand, the amount of data communication between different stages is increased, and on the other hand, data security risks are also introduced. For example, in some stages, data needs to be provided to a machine learning model in order to perform data processing with the help of the machine learning model, for example, to perform data analysis on the data using the machine learning model. However, providing the data to the machine learning model may affect the security of the data and increase the risk of data leakage.

In view of this, in the embodiments in the disclosure, an improved solution for data processing is provided. In this solution, in response to determining target data, the target data is stored into a target area, where data stored in the target area has corresponding identification, and the target data is determined based on a received user input. Data analysis is performed on the target data based on a target identification corresponding to the target data. A reply to the user input is presented based on a result of the data analysis.

In this way, after the data to be processed is queried, the data is not directly exposed to subsequent data analysis stages, but provided to the subsequent data analysis stages in the form of identification. On one hand, the amount of data communication between different stages can be reduced, and on the other hand, the data remains isolated between different stages, which can improve security.

Some example embodiments in the disclosure will be described in detail below with reference to the examples of the drawings.

The task management process described in the embodiments in the disclosure may be implemented in an application management platform, a terminal device installed with the application management platform, and/or a server-side corresponding to the application management platform. In the following examples, for the purpose of discussion, it is described from the perspective of the application management platform, such as the application management platform 110 shown in FIG. 1. The user interface presented by the application management platform 110 may be presented via the terminal device of the user 145, and the application management platform 110 may receive the user input via the terminal device of the user 145. In some embodiments in the disclosure, the user 145 is the terminal user of the target application 120. It should be understood that the user interface presented by the application management platform 110 may also be presented via the terminal device of the user 105, and the application management platform 110 may also receive the user input via the terminal device of the user 105. In some embodiments in the disclosure, the user 105 is the creator, manager or maintainer of the target application 120.

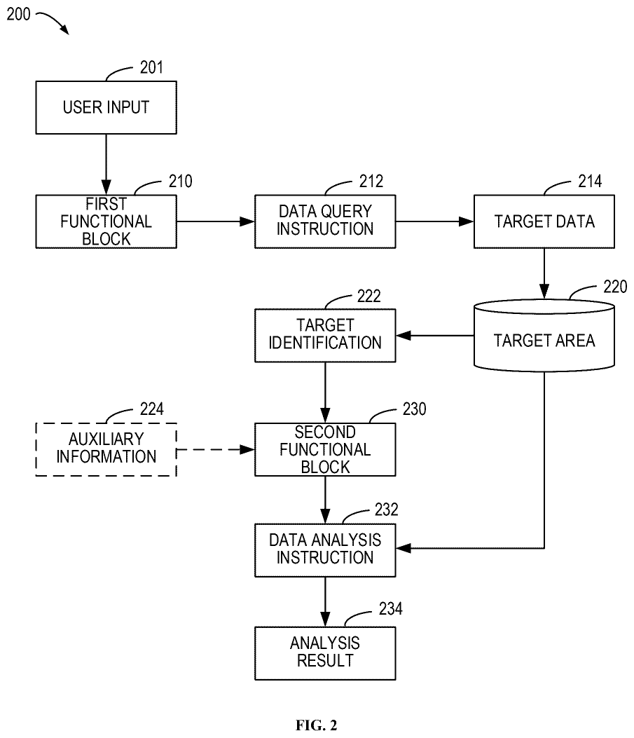

FIG. 2 illustrates a schematic diagram of an architecture 200 for data processing according to some embodiments in the disclosure. The architecture 200 may be implemented at the application management platform 110. In some embodiments, the operations performed by the application management platform 110 may specifically be performed by an application execution portion of the application management platform 110. The architecture 200 will be described with reference to the environment 100 in FIG. 1. The architecture 200 relates to a first functional block 210, a target area 220, and a second functional block 230.

In some embodiments, the application management platform 110 may receive a user input 201, and the user input 201 may include any suitable type of input, such as text, image, video, audio, data table, and the like. The application management platform 110 may receive the user input 201 in any suitable manner. For example, the application management platform 110 may receive the user input 201 from other electronic devices based on communication connections with the other electronic devices. For example, the application management platform 110 may collect the user input 201 via one or more of its own display, physical control, microphone, camera, and the like. The user input 201 may be presented in an interactive window, for example, the interactive window 142. In some embodiments, in the case where the user input 201 is a non-text type user input, the application management platform 110 may process the user input to determine the text corresponding to the user input.

The application management platform 110 may determine the target data 214 based on the received user input 201. Regarding the specific manner of determining the target data 214, in some embodiments, the first functional block 210 in the application management platform 110 may be configured to generate a data query instruction 212. The application management platform 110 may generate the data query instruction 212 by invoking a predetermined first functional block 210. For example, the first functional block 210 may be a Structured Query Language (SQL) functional block, and the data query instruction 212 generated by the first functional block 210 may be SQL.

The data query instruction 212 may inform how to query the target data 214, which can help to better understand the data. In some embodiments, the first functional block 210 may generate the data query instruction 212 with the help of a machine learning model. The machine learning model may be a model deployed locally on the application management platform 110, or may be a model deployed on other electronic devices.

The application management platform 110 may retrieve the target data 214 from one or more data sources by executing the data query instruction 212. The data source may be any suitable data source, including but not limited to structured objects and unstructured objects (for example, web pages, documents), and the like. The structured object may be any suitable type of object that may store or represent information in a structured manner, which may include but not limited to a data table, a database, and the like. The target data 214 may be, for example, original data retrieved from the data source. Taking the example where the data source includes a personnel information data table, the application management platform 110 may retrieve the target data 214 from the data table by executing the data query instruction 212. The target data 214 may be, for example, several rows of data in the data table (that is, personnel information of several persons).

The application management platform 110 may store the target data 214 into the target area 220 in response to determining the target data 214. The target area 220 may include, for example, a key-value type data storage system. Data stored in the target area 220 may have a corresponding identification. The identification may be used to indicate a storage location of the corresponding data in the target area. In some embodiments, different data in the target area 220 corresponds to different identifications (that is, each piece of data corresponds to a unique identification). The target identification 222 corresponding to the target data 214 may include, for example, a key in the key-value type data storage system.

The second functional block 230 in the application management platform 110 may generate the data analysis instruction 232 for data analysis on the target data at least based on the user input 201. The data analysis instruction 232 may be an instruction in any suitable programming language, for example, it may be a Python instruction.

In some embodiments, the second functional block 230 may further obtain the auxiliary information 224 related to the use of the target data 214, and generate the data analysis instruction 232 based on the user input 201 and the auxiliary information 224. The auxiliary information 224 may be determined by the application management platform 110 based on the target data 214 in response to determining the target data 214, for example. In some embodiments, the auxiliary information 224 may be stored in the target area 220. The second functional block 230 may read, based on the target identification 222, the auxiliary information 224 corresponding to the target identification 222 from the target identification 222. For example, the data in the target area 220 may exist in a form of “identification-data-auxiliary information”, and the second functional block 230 may retrieve the target area 220 based on the target identification 222 to obtain the auxiliary information 224 corresponding to the target identification 222.

In some embodiments, the auxiliary information 224 may not be stored in the target area 220, and the auxiliary information 224 may be associated with the target data 214 in any suitable manner. Alternatively or additionally, in some embodiments, the auxiliary information 224 may also be directly provided to the second functional block 230. Subsequently, the second functional block 230 may directly use the pre-obtained auxiliary information 224 to generate the data analysis instruction 232 in response to performing data analysis. In some embodiments, the auxiliary information may be stored in a separate information library, and the data in the information library may exist in a form of “identification-auxiliary information”. The second functional block 230 may directly retrieve the auxiliary information 224 from the information library based on the target identification 222. For another example, the second functional block 230 may further find the auxiliary information 224 associated with the target data 214 from one or more data sources directly based on the target identification 222. The disclosure does not limit the specific manner of obtaining the auxiliary information 224.

The auxiliary information 224 may include metadata information of the target data 214, and the metadata information may also be referred to as metadata. The metadata information of the target data 214 may include, for example, fields included in the target data 214. This may help the second functional block 230 to generate a more accurate data analysis instruction 232. Alternatively or additionally, the auxiliary information 224 may include source information of the target data 214. The source information of the target data 214 may indicate a source of the target data 214 and may include a description of the target data and/or the source of the target data, for example. Alternatively or additionally, the auxiliary information 224 may include description information corresponding to one or more fields included in the target data 214. For example, if a field in the target data includes a field specific to a certain field, the auxiliary information 224 may include a description of the field, which may help to better understand the field. It should be understood that the auxiliary information 224 may include one or more of a plurality of information, and the auxiliary information 224 may also include any other suitable content.

In some embodiments, the second functional block 230 may use a trained machine learning model to generate the data analysis instruction 232. The machine learning model may be a model deployed locally on the application management platform 110, or may be a model deployed on other electronic devices, and the machine learning model may be based on any suitable model structure. The second functional block 230 may, for example, provide the auxiliary information 224 and the user input 201 to the machine learning model together, to generate the data analysis instruction 232 using the machine learning model. In this way, specific data may not be provided to the model, and the model can learn information necessary for data analysis based on the auxiliary information, without affecting the accuracy of data analysis.

The data analysis instruction 232 may indicate, for example, summarizing, clustering, calculating, and the like on the target data 214. After obtaining the data analysis instruction 232, the application management platform 110 may execute the data analysis instruction 232 on the target data 214 based on the target identification 222. Specifically, the second functional block 230 in the application management platform 110 may read the target data 214 from the target area 220 based on the target identification 222. The second functional block 230 may load the read target data 214 into an execution environment of the data analysis instruction 232, and execute the data analysis instruction 232 on the target data 214 loaded into the execution environment. The execution environment may be a secure isolated environment, such as a trusted execution environment. For example, if the data analysis instruction 232 is a Python instruction, the corresponding execution environment is a Python execution environment. The second functional block 230 may load the target data 214 into Python, and execute the Python instruction in Python to process the target data 214.

The second functional block 230 may obtain a result of the data analysis on the target data 214 (which may also be referred to as an analysis result) 234 in response to the data analysis instruction 232 completely executed. For example, the second functional block 230 may obtain an execution result of the data analysis instruction 232 from the execution environment, and the result is the analysis result of the target data 214. The analysis result 234 may include, for example, at least one content of a chart type and/or at least one content of a form type. For example, the analysis result of the target data 214 may be a bar chart, and the bar chart can more clearly present differences between different data in the target data 214.

The application management platform 110 may present the reply to the user input 201 based on the analysis result 234. For example, the application management platform 110 may provide the analysis result 234 to the terminal device 146. The terminal device 146 may present an interactive interface (for example, the interactive window 142 of the user 145 and the digital assistant 122), and present the analysis result 234 in the interactive interface.

In conclusion, according to the embodiments in the disclosure, after the data is queried, the data is not directly exposed to the subsequent data analysis stages, but provided to the subsequent data analysis stages in the form of identification. On one hand, the amount of data communication between different stages can be reduced, and on the other hand, the data remains isolated between different stages, which can improve security.

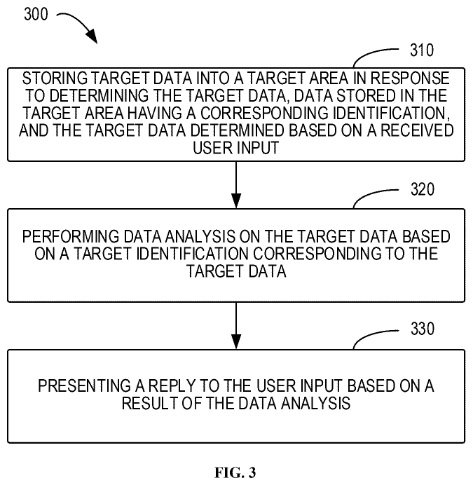

FIG. 3 illustrates a flowchart of a method for data processing 300 according to some embodiments in the disclosure. The method 300 may be implemented at the application management platform 110, for example, by the application execution portion of the application management platform 110. The method 300 will be described with reference to the environment 100 in FIG. 1.

At block 310, the application management platform 110 stores the target data into a target area in response to determining the target data, a data stored in the target area having a corresponding identification, and the target data determined based on a received user input.

At block 320, the application management platform 110 performs data analysis on the target data based on a target identification corresponding to the target data.

At block 330, the application management platform 110 presents a reply to the user input based on a result of the data analysis.

In some embodiments, performing the data analysis on the target data includes: obtaining auxiliary information related to the use of the target data; generating a data analysis instruction for the target data based on the user input and the auxiliary information using a machine learning model; and executing the data analysis instruction on the target data based on the target identification.

In some embodiments, the method 300 further includes: storing the auxiliary information in the target area in response to determining the target data, and obtaining the auxiliary information includes: reading the auxiliary information from the target area based on the target identification.

In some embodiments, the auxiliary information includes at least one of: metadata information of the target data, source information of the target data, or description information corresponding to one or more fields included in the target data.

In some embodiments, performing the data analysis on the target data includes: obtaining a data analysis instruction for the target data; loading the target data into an execution environment of the data analysis instruction based on the target identification; and executing the data analysis instruction on the target data loaded into the execution environment.

In some embodiments, the target data is determined by: invoking a predetermined first functional block to generate a data query instruction; and retrieving the target data from one or more data sources by executing the data query instruction, and the data analysis instruction for the data analysis is implemented by invoking a predetermined second functional block.

In some embodiments, the result of the data analysis includes at least one of the following types of content: at least one chart type, at least one form type.

In some embodiments, the target area includes a key-value type data storage system, and the target identification includes a key in the key-value type data storage system.

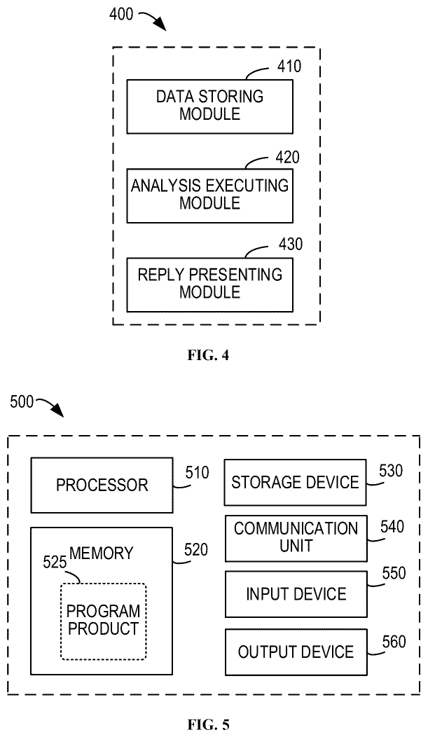

The embodiments in the disclosure further provide corresponding apparatuses for implementing the above methods or processes. FIG. 4 illustrates a schematic structural block diagram of an apparatus 400 for data processing according to some embodiments in the disclosure. The apparatus 400 may be implemented or included in the application management platform 110, for example. Various modules/components in the apparatus 400 may be implemented by hardware, software, firmware, or any combination thereof.

As shown in the figure, the apparatus 400 includes a data storing module 410 configured to store target data into a target area in response to determining the target data, data stored in the target area having a corresponding identification, and the target data determined based on a received user input. The apparatus 400 also includes an analysis executing module 420 configured to perform data analysis on the target data based on a target identification corresponding to the target data. The apparatus 400 also includes a reply presenting module 430 configured to present a reply to the user input based on a result of the data analysis.

In some embodiments, the analysis execution module 420 is further configured to: obtain auxiliary information related to the use of the target data; generate a data analysis instruction for the target data based on the user input and the auxiliary information using a machine learning model; and execute the data analysis instruction on the target data based on the target identification.

In some embodiments, the apparatus 400 further includes an auxiliary information storage module configured to store the auxiliary information in the target area in response to determining the target data, and the analysis execution module 420 is further configured to read the auxiliary information from the target area based on the target identification.

In some embodiments, the auxiliary information includes at least one of: metadata information of the target data, source information of the target data, or description information corresponding to one or more fields included in the target data.

In some embodiments, the analysis execution module 420 is further configured to: obtain a data analysis instruction for the target data; load the target data into an execution environment of the data analysis instruction based on the target identification; and execute the data analysis instruction on the target data loaded into the execution environment.

In some embodiments, the target data is determined by: invoking a predetermined first functional block to generate a data query instruction; and retrieving the target data from one or more data sources by executing the data query instruction, and the data analysis instruction for the data analysis is implemented by invoking a predetermined second functional block.

In some embodiments, the result of the data analysis includes at least one of the following types of content: at least one chart type, at least one form type.

In some embodiments, the target area includes a key-value type data storage system, and the target identification includes a key in the key-value type data storage system.

The units and/or modules included in the apparatus 400 may be implemented in various manners, including software, hardware, firmware, or any combination thereof. In some embodiments, one or more units and/or modules may be implemented using software and/or firmware, such as machine-executable instructions stored on a storage medium. In addition to the machine-executable instructions or as an alternative, some or all of the units and/or modules in the apparatus 400 may be implemented at least in part by one or more hardware logic components. As an example rather than a limitation, example types of hardware logic components that may be used include a field programmable gate array (FPGA), an application specific integrated circuit (ASIC), an application specific standard product (ASSP), a system on chip (SOC), a complex programmable logic device (CPLD), and the like.

FIG. 5 illustrates a block diagram of an electronic device 500 in which one or more embodiments in the disclosure may be implemented. It should be understood that the electronic device 500 shown in FIG. 5 is only example, and should not constitute any limitation on the function and scope of the embodiments described herein. The electronic device 500 shown in FIG. 5 may include or be implemented as the application management platform 110 in FIG. 1, or the apparatus 400 in FIG. 4.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processor 510 may be a physical or virtual processor and may execute various processes according to programs stored in the memory 520. In a multi-processor system, a plurality of processors execute computer-executable instructions in parallel to improve the parallel processing capability of the electronic device 500.

The electronic device 500 usually includes a plurality of computer storage media. Such media may be any available media accessible to the electronic device 500, including but not limited to volatile and non-volatile media, removable and non-removable media. The memory 520 may be a volatile memory (for example, a register, a cache, a random access memory (RAM)), a non-volatile memory (for example, a read-only memory (ROM), an electrically erasable programmable read-only memory (EEPROM), a flash memory), or a certain combination thereof. The storage device 530 may be a removable or non-removable medium, and may include a machine-readable medium, such as a flash drive, a magnetic disk, or any other medium, which may be capable of storing information and/or data and may be accessed within the electronic device 500.

The electronic device 500 may further include additional removable/non-removable, volatile/non-volatile storage media. Although not shown in FIG. 5, a disk drive for reading or writing from a removable, non-volatile disk (for example, a “floppy disk”) and an optical disk drive for reading or writing from a removable, non-volatile optical disk may be provided. In these cases, each drive may be connected to a bus (not shown) by one or more data media interfaces. The memory 520 may include a computer program product 525 having one or more program modules configured to perform various methods or actions of various embodiments in the disclosure.

The communication unit 540 implements communication with other electronic devices through a communication medium. Additionally, the functions of the components of the electronic device 500 may be implemented in a single computing cluster or a plurality of computing machines that can communicate through a communication connection. Therefore, the electronic device 500 can operate in a networked environment using a logical connection with one or more other servers, network personal computers (PC), or another network node.

The input device 550 may be one or more input devices, such as a mouse, a keyboard, a trackball, and the like. The output device 560 may be one or more output devices, such as a display, a speaker, a printer, and the like. The electronic device 500 may also communicate, as needed, with one or more external devices (not shown) through the communication unit 540, such as a storage device, a display device, etc., communicate with one or more devices that enable the user to interact with the electronic device 500, or communicate with any device that enables the electronic device 500 to communicate with one or more other electronic devices (e.g., a network card, a modem, etc.). Such communication may be performed via an input/output (I/O) interface (not shown).

According to an example implementation in the disclosure, a computer-readable storage medium is provided, on which computer-executable instructions are stored, and the computer-executable instructions are executed by a processor to implement the method described above. According to an example implementation in the disclosure, a computer program product is further provided, which is tangibly stored on a non-transitory computer-readable medium and includes computer-executable instructions, and the computer-executable instructions are executed by a processor to implement the method described above.

Various aspects in the disclosure are described herein with reference to flowcharts and/or block diagrams of the method, apparatus, device, and computer program product implemented according to the disclosure. It should be understood that each block of the flowcharts and/or block diagrams and combinations of blocks in the flowcharts and/or block diagrams may be implemented by computer-readable program instructions.

These computer-readable program instructions may be provided to a processor of a general-purpose computer, a special-purpose computer, or other programmable apparatus for data processing, so that a machine is produced. When these instructions are executed by the processor of the computer or other programmable apparatus for data processing, the apparatus for implementing the functions/actions specified in one or more blocks of the flowcharts and/or block diagrams is generated. These computer-readable program instructions may also be stored in a computer-readable storage medium. These instructions enable the computer, the programmable apparatus for data processing, and/or other devices to work in a specific manner. Therefore, the computer-readable medium storing the instructions includes a manufacture including instructions for implementing various aspects of the functions/actions specified in one or more blocks of the flowcharts and/or block diagrams.

The computer-readable program instructions may be loaded onto a computer, other programmable apparatus for data processing, or other device, causing a series of operational steps to be executed on the computer, other programmable apparatus for data processing, or other device to generate a computer-implemented process, so that the instructions executed on the computer, other programmable apparatus for data processing, or other device implement the functions/actions specified in one or more blocks of the flowcharts and/or block diagrams.

The flowcharts and block diagrams in the drawings illustrate the architecture, functionality, and operation of possible implementations of systems, methods, and computer program products according to various implementations in the disclosure. In this regard, each block in the flowcharts or block diagrams may represent a module, a program segment, or a portion of instructions, and the module, program segment, or portion of instructions contains one or more executable instructions for implementing specified logical functions. In some alternative implementations, the functions noted in the blocks may also occur out of the order noted in the figures. For example, two blocks shown in succession may, in fact, be executed substantially concurrently, or the blocks may sometimes be executed in a reverse order, depending upon the functionality involved. It should also be noted that each block of the block diagrams and/or flowcharts, and combinations of blocks in the block diagrams and/or flowcharts, may be implemented by special purpose hardware-based systems that perform the specified functions or acts, or combinations of special purpose hardware and computer instructions.

Various implementations in the disclosure have been described above, and the above description is only examples, not exhaustive, and is not limited to the disclosed implementations. Many modifications and variations will be apparent to those of ordinary skill in the art without departing from the scope and spirit of the described implementations. The terminology used herein is chosen to best explain the principles of the implementations, the practical application or technical improvement in the market, or to enable others of ordinary skill in the art to understand the implementations disclosed herein.

1. A method for data processing, comprising:
storing first data into a first area in response to determining the first data, data stored in the first area having a corresponding identification, and the first data determined based on a received user input;
performing data analysis on the first data based on a first identification corresponding to the first data; and
presenting a reply to the user input based on a result of the data analysis.

2. The method of claim 1, wherein performing the data analysis on the first data comprises:
obtaining auxiliary information related to use of the first data;
generating a data analysis instruction for the first data based on the user input and the auxiliary information using a machine learning model; and
executing the data analysis instruction on the first data based on the first identification.

3. The method of claim 2, further comprising:
storing the auxiliary information in the first area in response to determining the first data, and wherein obtaining the auxiliary information comprises:
reading the auxiliary information from the first area based on the first identification.

4. The method of claim 2, wherein the auxiliary information comprises at least one of:
metadata information of the first data,
source information of the first data, or
description information corresponding to one or more fields comprised in the first data.

5. The method of claim 1, wherein performing the data analysis on the first data comprises:
obtaining a data analysis instruction for the first data;
loading the first data into an execution environment of the data analysis instruction based on the first identification; and
executing the data analysis instruction on the first data loaded into the execution environment.

6. The method of claim 1, wherein the first data is determined by:
invoking a first functional block to generate a data query instruction; and
retrieving the first data from one or more data sources by executing the data query instruction, and
the data analysis instruction for the data analysis is implemented by invoking a second functional block.

7. The method of claim 1, wherein the result of the data analysis comprises at least one of the following types of content:
at least one chart type,
at least one form type.

8. The method of claim 1, wherein the first area comprises a key-value type data storage system, and the first identification comprises a key in the key-value type data storage system.

9. An electronic device, comprising:
at least one processor; and
at least one memory, wherein the at least one memory is coupled to the at least one processor and stores instructions configured to be executed by the at least one processor, and the instructions, when executed by the at least one processor, cause the electronic device to perform operations comprising:
storing first data into a first area in response to determining the first data, data stored in the first area having a corresponding identification, and the first data determined based on a received user input;
performing data analysis on the first data based on a first identification corresponding to the first data; and
presenting a reply to the user input based on a result of the data analysis.

10. The electronic device of claim 9, wherein performing the data analysis on the first data comprises:
obtaining auxiliary information related to use of the first data;
generating a data analysis instruction for the first data based on the user input and the auxiliary information using a machine learning model; and
executing the data analysis instruction on the first data based on the first identification.

11. The electronic device of claim 10, wherein the operations further comprise:
storing the auxiliary information in the first area in response to determining the first data, and wherein obtaining the auxiliary information comprises:
reading the auxiliary information from the first area based on the first identification.

12. The electronic device of claim 10, wherein the auxiliary information comprises at least one of:
metadata information of the first data,
source information of the first data, or
description information corresponding to one or more fields comprised in the first data.

13. The electronic device of claim 9, wherein performing the data analysis on the first data comprises:
obtaining a data analysis instruction for the first data;
loading the first data into an execution environment of the data analysis instruction based on the first identification; and
executing the data analysis instruction on the first data loaded into the execution environment.

14. The electronic device of claim 9, wherein the first data is determined by:
invoking a first functional block to generate a data query instruction; and
retrieving the first data from one or more data sources by executing the data query instruction, and
the data analysis instruction for the data analysis is implemented by invoking a second functional block.

15. The electronic device of claim 9, wherein the result of the data analysis comprises at least one of the following types of content:
at least one chart type,
at least one form type.

16. The electronic device of claim 9, wherein the first area comprises a key-value type data storage system, and the first identification comprises a key in the key-value type data storage system.

17. A non-transitory computer-readable storage medium, storing a computer program thereon, wherein the computer program is executable by a processor to perform operations comprising:
storing first data into a first area in response to determining the first data, data stored in the first area having a corresponding identification, and the first data determined based on a received user input;
performing data analysis on the first data based on a first identification corresponding to the first data; and
presenting a reply to the user input based on a result of the data analysis.

18. The storage medium of claim 17, wherein performing the data analysis on the first data comprises:
obtaining auxiliary information related to use of the first data;
generating a data analysis instruction for the first data based on the user input and the auxiliary information using a machine learning model; and
executing the data analysis instruction on the first data based on the first identification.

19. The storage medium of claim 18, wherein the operations further comprise:
storing the auxiliary information in the first area in response to determining the first data, and wherein obtaining the auxiliary information comprises:
reading the auxiliary information from the first area based on the first identification.

20. The storage medium of claim 18, wherein the auxiliary information comprises at least one of:
metadata information of the first data,
source information of the first data, or
description information corresponding to one or more fields comprised in the first data.
